(19) United States
(12) Patent Application Publication
(10) Pub. No.: US 2014/0358663 A1
(43) Pub. Date: Dec. 4, 2014

(54) SYSTEM AND METHOD FOR CONTEXT DIFFERENTIAL REDEMPTION

(71) Applicant: XENLULU LLC, Hingham, MA (US)

(72) Inventors: Joseph Anthony Wheeler, Hingham, MA (US); Brandon Charles Hill, Boyne City, MI (US)

(73) Assignee: XENLULU LLC, Hingham, MA (US)

(21) Appl. No.: 14/069,529

(22) Filed: Nov. 1, 2013

Related U.S. Application Data
(60) Provisional application No. 61/897,254, filed on Oct. 30, 2013.
(60) Provisional application No. 61/870,589, filed on Aug. 27, 2013.
(60) Provisional application No. 61/828,893, filed on May 30, 2013.

(51) Int. Cl. G06Q 30/02

(52) U.S. Cl. CPC G06Q 30/0233
USPC 705/14.33

(57) ABSTRACT

The invention provides systems and methods for administering a rewards program in which a discount is offered to participants, and in which individuals redeem earned points at a personalized redemption rate. Points are earned by both shopping and social media activity. The personalized redemption rate is determined according to the activity of a user. The rewards program preferably includes real-time earning of points and real-time price reductions. In certain aspects, the invention provides a method of influencing consumer behavior that includes using a computer system for giving consumers reward points for performing activities, determining a redemption rate for each consumer, offering the consumers a discount on a purchase, and—for each consumer that accepts the offer—depleting that consumer's reward points by an amount inversely proportional to that consumer's redemption rate.

### CROSS-REFERENCE TO RELATED APPLICATIONS

This application claims priority to, and the benefit of, U.S. Provisional Patent Application Ser. No. 61/828,893, filed May 30, 2013; U.S. Provisional Patent Application Ser. No. 61/870,589, filed Aug. 27, 2013; and to U.S. Provisional Patent Application Ser. No. 61/897,254, filed Oct. 30, 2013, the contents of each of which are incorporated by reference for all purposes.

### FIELD OF THE INVENTION

The invention generally relates to rewards programs that offer personalized reward redemption.

### BACKGROUND

Rewards programs play an important role in building a relationship between a consumer and a merchant. Consumers appreciate that they get something for their loyalty. Since the loyalty is encouraged, the merchant has more opportunities to share new products or services with the consumer. In fact, principles of a market economy hold that there is immense benefit to society in terms of increased consumer welfare if each consumer can be matched up with each product that is available at the price that that consumer wants to pay. A rewards program provides a long series of such welfare-producing match-ups, allowing merchants to try discounting to different prices and encouraging consumers to try different offerings from merchants.

Unfortunately, to participate in a rewards program, a merchant must make compromises that limit the benefits that society can reap. For example, a merchant may want to discount a product so that more people can obtain it. But a simple calculation of units sold times amount of discount cannot exceed the merchant's total margin. Airlines, credit card companies, and other firms that have administered rewards programs have tried different strategies to improve the effectiveness of rewards programs. However, perhaps due to an innate human sense of fairness, customers are put off by naked giveaways to favored customers. If a rewards program is to nourish customer trust, discounts and deals must be offered fairly across the board, even where that means that the program will have little to offer to some of its participants.

### SUMMARY

The invention provides systems and methods for administering a rewards program in which some certain discount can be offered to all participants, and in which any given participant obtains that discount by redeeming earned points at a personalized redemption rate. Points can be earned by activities that can include shopping, social media activity, or both. The personalized redemption rate is determined according to factors such as the history of activity of a user. For example, a user with frequent purchases or frequent promotions of a brand on a social media web site can be offered a discount on a purchase for a certain number of points. Another user with infrequent purchases or infrequent visits to the social media website can be offered the same discount for a different number of points (e.g., fewer) to incentivize that user to get more involved in the program. Alternatively, a merchant can give a highly involved user a more favorable redemption rate (e.g., points/discount value), thus gearing the whole program to incentivize participants to make more purchases and promote brands via social media more frequently.

The rewards program preferably includes real-time earning of points and real-time price reductions. Since consumers can see their points accrue as they perform shopping and social media activities, and since they also see prices drop right in front of their eyes at the time of purchase based on their participation in the program, the real-time nature of the program is communicated and the consumer comes to understand the benefits to be had from staying involved in the dynamic, evolving program. The consumer has an incentive to communicate to others about products via social media, or about the rewards program itself, giving more people the opportunity to experience the benefits of the products and program. Earning points can be based on activities (purchasing, liking a brand) and merchants can create specific structured activities styled as missions that consumers complete to earn points. The mission structure provides a tool by which a merchant can accomplish one goal, such as promoting a new brand by specific media such as photos on a social networking site, while consumers are engaged in an interesting game-like activity that is rewarding in its own right.

Since the rewards program can include a personalized redemption rate, consumers can be given personalized discounts based on variables relating to their purchase history, social media activity, participation in the program, or other things a merchant or administrator is interested in including. Since rewards can be given to the consumers as discounts in which all consumers receive the same discount on any given purchase, the program avoids giving different prices to different people and thus builds trust while discouraging arbitrage. These features of personalized redemption rate and consistent discounts make for a rewards program that yields high consumer welfare and delivers desired products to people at prices that they wish to pay.

In certain aspects, the invention provides a method of influencing consumer behavior that includes using a computer system for giving consumers reward points for performing activities, determining a redemption rate for each consumer, offering the consumers a discount on a purchase, and—for each consumer that accepts the offer—depleting that consumer's reward points by an amount inversely proportional to that consumer's redemption rate.

The consumers may be given reward points for performing activities that include the use of a social network website and the purchasing of a product.

Offering the consumers a discount on a purchase can be done by providing the consumer with a computer executable application (e.g., a mobile app) that the consumer can execute on a mobile computing device to cause the mobile device to scan a product code and displaying on the mobile device a discounted price for product. The discounted price can be shown as a “rollback”, e.g., by displaying an original price number, displaying a transition, and displaying a final discounted price number (the transition can be an animation of numbers between the original price number and the final discounted price number).

Methods of the invention can also include mission-based embodiments, in which the method includes assigning missions to a consumer or giving consumers reward points for performing activities that include performing assigned missions. Completion of the assigned missions can be verified by receiving an image from a consumer.

Assigned missions can include recommending a product through the use of a web site, uploading a picture of a product, recruiting another person to join the rewards program, others, or a combination thereof. Missions themselves may be influenced according to a differential algorithm. For example, missions can be assigned at a frequency that is influenced by a speed of completion of previously-assigned missions. Missions can be personalized to a consumer based on information known about that consumer.

Preferred embodiments include personalized reward redemption rates. In some embodiments, the determining a redemption rate for each consumer is done by calculating a value for a function in which variables could include any of an amount of points earned, a frequency at which points have been earned, an amount of social network activity in a period of time, a time since a last transaction, and a time of day. The calculation may also make reference to a discriminant factor, such as a status in a rewards program.

In other aspects, the invention provides method of providing rewards to a user by storing a user profile in tangible, non-transitory memory of a computing device. The profile includes a user history and a stored value of reward points. The method further includes analyzing with a processor coupled to the memory the user history with a scoring algorithm to provide a score that is indicative of the relative value for the user profile. Information is received from a user identifying a product that is available for purchase at a price. The method includes offering the product to the user for a discounted price on the condition that the stored value of reward points decreases by a redemption cost inversely proportional to the relative value.

In related aspects, the invention provides method of providing rewards to a user by storing a user profile in tangible, non-transitory memory of a computing device. The profile includes a user history and a stored value of reward points. The method further includes analyzing with a processor coupled to the memory the user history with a scoring algorithm to provide a redemption value. Information is received from a user identifying a product that is available for purchase at a price. The method includes offering the product to the user for a discounted price on the condition that the stored value of reward points decreases by a redemption cost that is based on the redemption value.

In certain aspects, the invention provides process for providing products to people. The process includes tallying an amount of points earned by each of a plurality of people in a computer system and offering an incentive (such as a discount from a retail price) to each of the plurality of people. The incentive is provided to a first person and to a second person. The first person's amount of points is depleted by a certain amount, and the second person's amount of points is depleted by a different amount not equal to the certain amount. The tallying can include storing an amount of points that each of the plurality of people earn via both online activity and purchasing.

In some embodiments, the certain amount and the different amount each represent a personalized discount that is personalized based on a history of earning points of the respective person. In general, the certain amount and the different amount are determined according to at least one variable for which the first person and the second person have a second value stored in the computer system. Preferably, the at least one variable relates to a rate at which the amount of points is earned by each of the plurality of people.

Offering the incentive can be done by a real-time rewards display such as, for example, by causing a mobile device to display the discounted price. The display can be a real-time price rollback by causing a computer device to display an animation showing the retail price change to the discounted price. The incentive can be offered in-store (e.g., shown on the screen of a shoppers' smartphone or a point-of-sale (POS) terminal) or online.

The process can include mission assignment and mission structures. For example, missions can be assigned to each of the plurality of people, with the points earned by performing the assigned missions. In some embodiments, the missions include purchasing a product and providing to the computer system verification that the product was purchased. Additionally or alternatively, the missions include promoting a product to users of a web site.

Aspects of the invention provide an apparatus for facilitating a purchase. The apparatus has a mobile device form-factor body, a scanning device, and a processor coupled to a memory and the scanning device and housed by the body. The processor is operable to cause the apparatus to scan a product code to determine an identity of a product, determine that a user of the apparatus is a participant in a reward program, display a predetermined discount to the user, and debit a rewards point account of the user a personalized amount of rewards points. The personalized amount of the rewards points is determined based on the user's participation in the program. The scanning device could be a camera or a barcode scanner.

In certain aspects, the invention provides system for influencing a consumer. The system includes a computer device in which a memory coupled to a processor is operable to cause the system to give consumers reward points for performing activities, determine a redemption rate for each consumer, offer the consumers a discount on a purchase, and—for each consumer that accepts the offer—deplete that consumer's reward points by an amount inversely proportional to that consumer's redemption rate. The system may be operable to give the consumers reward points for performing activities that include the use of a social network website and the purchasing of a product.

In some mobile app embodiments, offering the consumers a discount on a purchase is done by providing the consumer with a computer executable application that a consumer can execute on a mobile computing device to cause the mobile device to scan a product code, and displaying on the mobile device a discounted price for product.

In some web embodiments, offering the consumers a discount on a purchase is done by providing the consumer with a product page that a customer views in a browser, and displaying in the browser a discounted price for product.

The system can be operated to perform real-time rewards price rollbacks. Displaying the discounted price can be done by displaying an original price number, displaying a transition, and displaying a final discounted price number. The transition can include an animation of numbers scrolling between the original price number and the final discounted price number.

The system can be operated to perform mission-based embodiments. In mission based embodiments, consumers are given reward points for performing activities that include performing assigned missions. The system can be operated for verifying completion of the assigned missions (e.g., by receiving an image from a consumer). Assigned missions can include recommending a product through the use of a web site. In certain embodiments, the missions are assigned at a frequency that is influenced by a speed of completion of previously-assigned missions.

In certain aspects, the invention provides a system of providing rewards to a user, the system comprising one or more computers operable to store a user profile in a tangible, non-transitory memory (the profile includes a user history and a stored value of reward points), analyze using a processor the user history with a scoring algorithm to provide a score that is indicative of the relative value for the user profile, receive information from a user identifying a product that is available for purchase at a price, and offer the product to the user for a discounted price on the condition that the stored value of reward points decreases by a redemption cost inversely proportional to the relative value.

Other aspects of the invention provide a system for providing products. The system includes a computer system operable to tally an amount of points earned by each of a plurality of people, offer an incentive to each of the plurality of people, provide the incentive to a first person while depleting the first person's amount of points by a certain amount, and provide the incentive to a second person while depleting the second person's amount of points by a different amount not equal to the certain amount. Tallying may be done storing an amount of points that each of the plurality of people earn via both online activity and purchasing. In some embodiments, the incentive comprises a discounted price that is lower than a retail price.

In certain embodiments, the certain amount and the different amount are determined according to at least one variable for which the first person and the second person each have a value stored in the computer system. Preferably, the at least one variable relates to a rate at which the amount of points is earned by each of the plurality of people. The certain amount and the different amount may each represent a personalized discount that is personalized based on a history of earning points of the respective person.

### BRIEF DESCRIPTION OF THE DRAWINGS

FIG. 1 shows a mobile device for participating in a rewards program.

FIG. 2 shows a computer device for participating in a rewards program.

FIG. 3 shows a display according to embodiments of the invention.

FIG. 4 shows a display for social media activity for earning points.

FIG. 5 shows a display for identifying a product and shopping for earning points.

FIG. 6 shows a display for receiving a certain discount at a personalized redemption rate.

FIG. 7 shows receiving the discount at a different redemption rate by a different user.

FIG. 8 diagrams methods of the invention.

FIG. 9 illustrates identifying a product.

FIG. 10 shows shopping using a device.

FIG. 11 shows viewing a discount via a device.

FIG. 12 depicts components of a system of the invention.

FIG. 13 diagrams components of a system.

### DETAILED DESCRIPTION

The invention provides a mobile-based loyalty program that allows customers to earn redeemable points through both purchasing and social behavior. Points may be redeemed for incentives. Incentives may include products, discounts, favored treatments, services, others, or a combination thereof. Preferably, an incentive is given to different customers at personalized point costs, and the point costs can be determined based on each customer's history of participation in the program, earning points, shopping, social activity online, or a combination thereof. Determining a personalized point cost can be done by calculating a formula, looking up values in a table, receiving extrinsic input, or making reference to a discriminant factor.

In a preferred embodiment, points are redeemed in real-time by a person through their use of a computer device or mobile device. For a given purchase, point redemption can be done in any suitable way including, for example, via a merchant's point-of-sale (POS), in online shopping, or through use of a mobile device. In some embodiments, a person can redeem points using their mobile device to identify a product (e.g., by scanning a product or service code such as a bar code or QR code) and being offered, via the mobile device, an incentive. The incentive can be presented as a discount on the purchase (purchase can refer to goods, services, or both). In some embodiments, presentation of the discount is done by a real-time display. The consumer opts to engage the rewards program and views a purchase with price on a computing device. A discount incentive is offered in the form of the original, retail price transitioning to the discounted price (e.g., as a “rollback”). Additionally, in some embodiments, discount amounts can be selected by consumers by selecting a number of points to redeem.

Systems and methods of the invention provide useful benefits to consumers and merchants. For consumers, the invention provides consumers with a way to achieve significant savings based on both their shopping and social behaviors. Additionally, as discussed herein, participating in missions and social activities can be engaging and interesting in their own right. Further, by promoting and communicating about goods and services within the context of a rewards program, consumers are disseminating actionable information about the availability and desirability of goods and services to other consumers. Retailers, both online and in-store, are given a powerful tool for conversion (turning browsers into buyers). Due to the fact that a retailer can engage the rewards program to offer a discount in real time and in response to a consumer's inquiry, retailers can use tools of the invention to influence consumers who are “on the fence” without having to run an indiscriminate sale. Moreover, retailers can use system and methods of the invention to tailor offerings to consumers, as well as their interactions with consumers, to achieve the sales goals of the company for that particular product or service. For hospitality or entertainment companies, the invention provides their guests with a positive experience that drive up transaction volume, spend per visit, repeat visit and positive social advocacy.

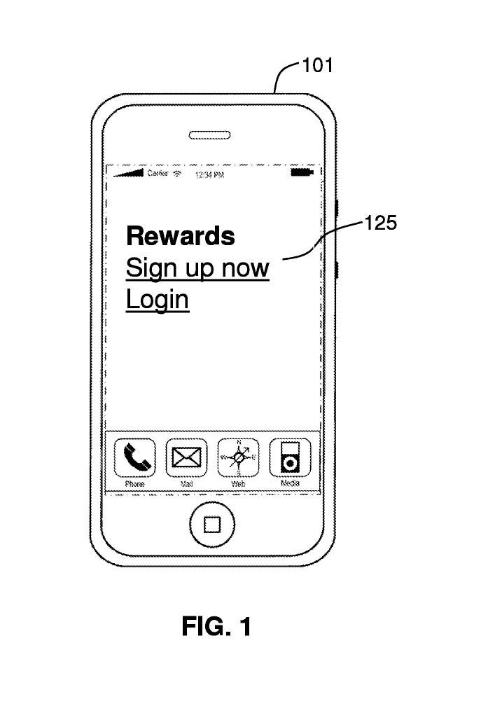

FIG. 1 shows a mobile device 101 for participating in a rewards program. In some embodiments, a user will register for, or sign up for, ongoing participation in a rewards program. Registration is preferably done via user of a computer such as a mobile device 101 or through a web page. Registration and other functions of the invention described herein can be accomplished through use of a display 125 to interact, via a mobile app, web page, or other command structure, with program. In some embodiments, rewards points are earned for registering for the program, for downloading the mobile app, or for other activities, such as for first accessing a web page, or for use of a web page.

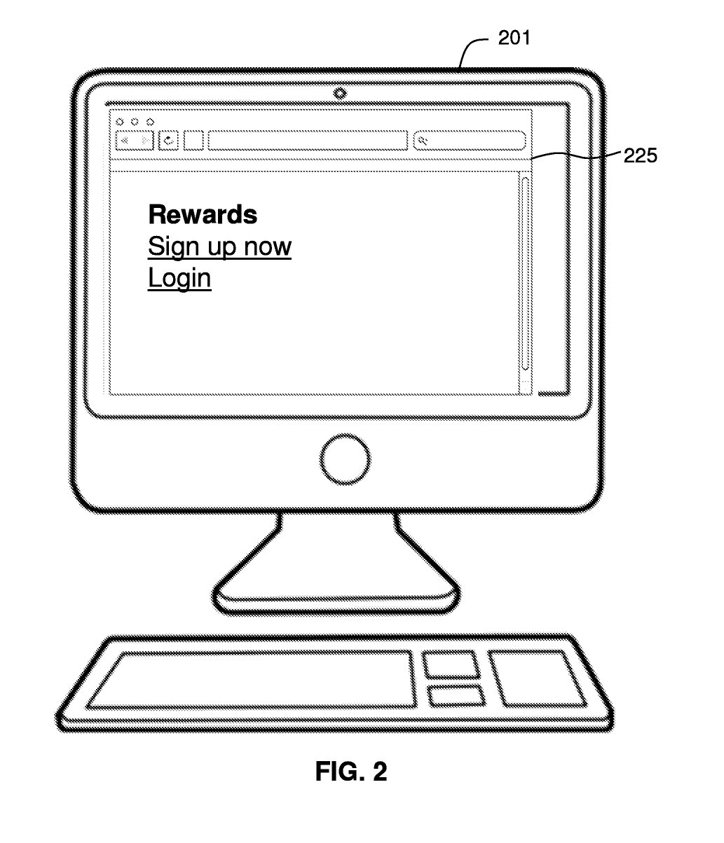

FIG. 2 shows a computer device 201 with display 225 for participating in a rewards program. Display 225 can be provided using a web page, a dedicated computer application, via email, or other methods and systems. As shown in FIG. 2, a consumer can use display 225 to log in to an account or to sign up for a rewards program.

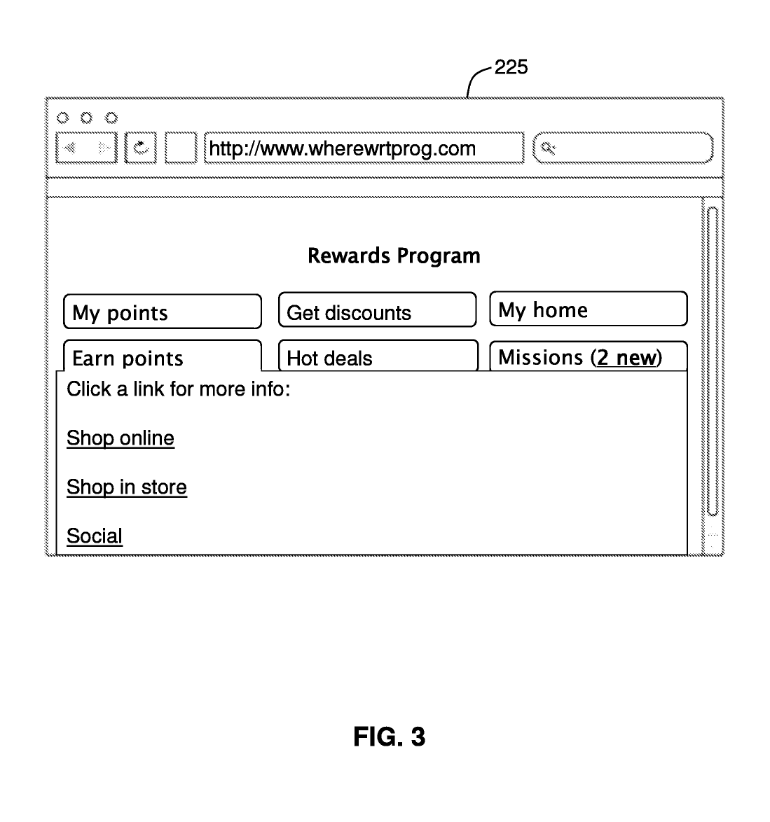

FIG. 3 shows a display according to embodiments of the invention. In some embodiments, a rewards program uses a web-based account and home page. A consumer may log into their account and view the home page to initiate activities described herein. Rewards are earned through online activity such as through the use of social media web sites and also through purchasing activity such as through buying products in stores and online. In certain embodiments, a rewards program includes a mission component.

A mission component can be used to structure a consumer's participation in a rewards program according to gaming experiences. A participant can be included in ongoing or interactive tasks, which may be referred to as missions. Missions can be created by participating retailers or service firms (e.g., hospitality firms) or can be created by administrators of the rewards program itself. The invention provides a mobile rewards solution that allows a user to earn reward points from both purchase behavior and social behavior and redeem them for real time discounts in retail, online and mobile settings. Retailers or hospitality customers can also provide their customers with non-financial rewards based on purchase and social behaviors such as preferred seating at an event, moving the front of a line at a theme park or choosing from low cost complimentary merchandize. As with redemption rates (discussed elsewhere herein), mission assignment and non-financial rewards can be determined based on a value or status of a consumer or their profile. For example, redemption rates, non-financial rewards, mission assignment, and other offerings of the program can be based on a level of points achieved, a user's status on a leaderboard after a specific time period, or other factors. In some embodiments, missions are time-based and must be complete within a specific time window.

Generally assigning a mission will include providing a consumer with information identifying at least one task to be performed and instructions on how to verify completion. For example, a mission can be assigned by letting a user click a link to open a new mission, or by emailing a mission to a consumer. The mission can give, as a task, that a consumer is to refer to a certain product online. The rewards program can verify completion by having the consumer allow access to a consumer's information within a third-party social networking site. When the consumer mentions, links to, review, or “likes” the certain product within the third-party social network site, the rewards program server receives and notes verification of mission completion.

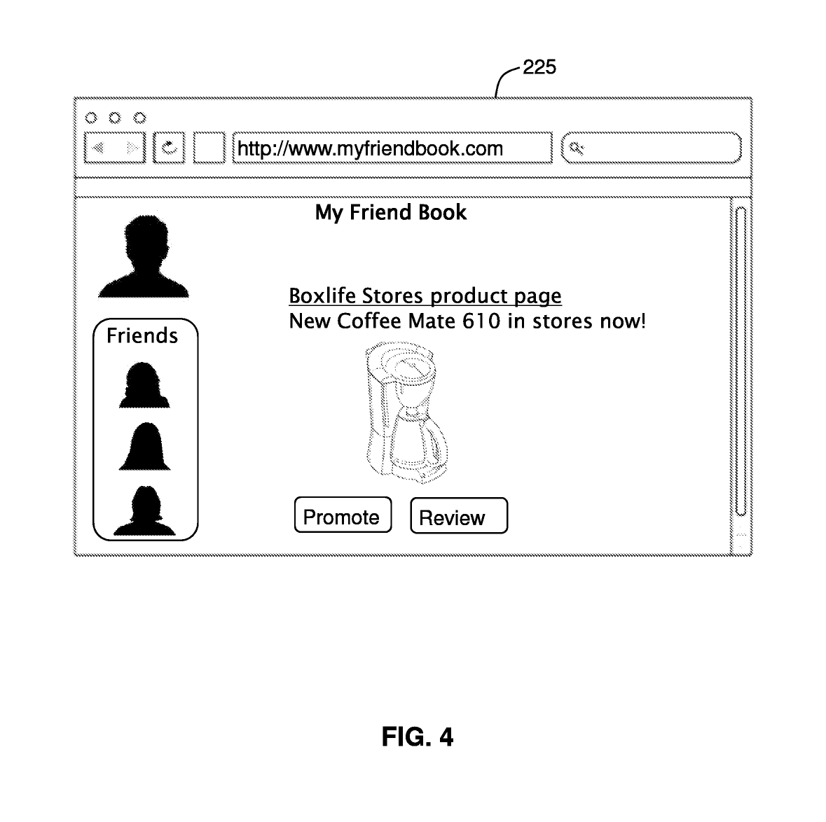

FIG. 4 shows a display for social media activity for earning points. Here, the display 225 depicts a consumer having been given a mission to promote a product (e.g., a coffee maker) on a social media web site for a certain number of points. In some embodiments, a mission could include a second activity component (e.g., an optional one) such as writing a full review for additional points. When the user promotes the product, code is executing information a server system that the user has completed the mission. The program server system—keeping a running tally of the user's points—can then increment the tally the appropriate amount.

Additionally, besides just social activity, purchasing activity can earn points in a rewards program of certain embodiments.

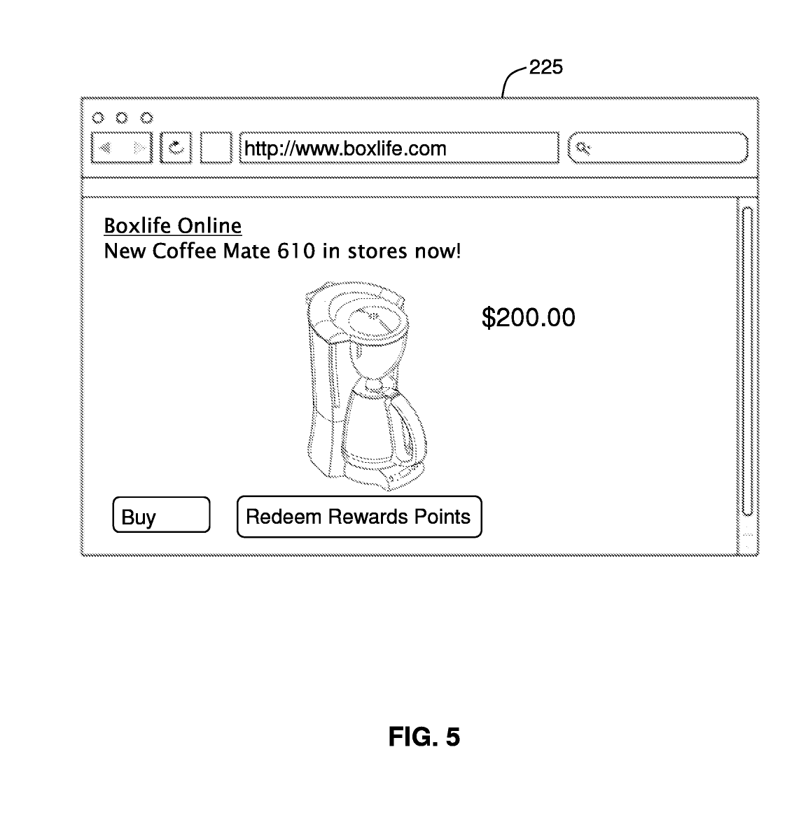

FIG. 5 shows a display for identifying a product and shopping for earning for earning points. In the depicted display, a consumer has gone to a retailers web page for making online purchases. In some embodiments, the retailer and the rewards program administrator cooperate. In certain embodiments, a retailer administrates a rewards program of the invention or a component of it. A user can purchase the product (e.g., at the offered amount) to receive rewards points.

Further, a user can redeem points for incentives such as discounts, giveaways, and services. As shown in FIG. 5, a product can be purchased by redeeming rewards points (e.g., to get it for free or at a discount). In preferred embodiments, systems and methods of the invention are used for calculating a personalized discount. As shown herein, the invention can be used to discount a price before a user's eyes based on a real time allocation of points toward a specific purchase. Further, a discount can be offered equally for different users, but can be personalized via a personalized redemption rate.

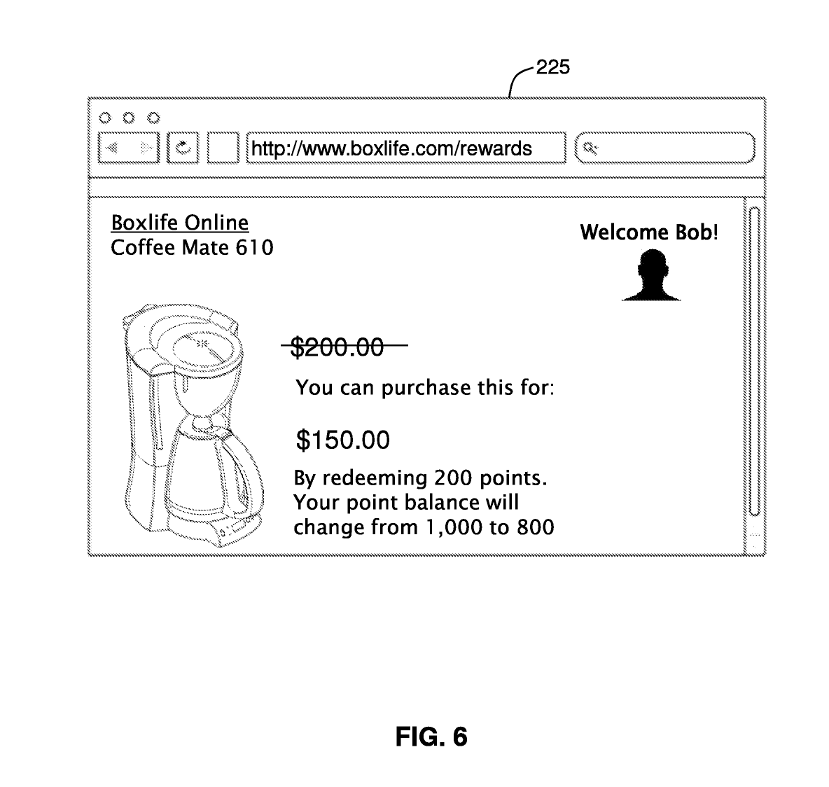

FIG. 6 shows a display for receiving a certain discount at a personalized point redemption rate. As shown in FIG. 6, a user (e.g., “Bob”) can redeem points to receive a discount. The user may be offered a certain redemption rate such as, for example, 200 points for a $50 discount. While not shown in FIG. 6, in some embodiments, a user can select an amount of points to redeem to obtain a desired discount (e.g., user can dial in a precise number of points, or can be offered two or a few options). A different user may be offered a personalized discount or the same discount, but based on a personalized redemption rate that is different than the first user's redemption rate.

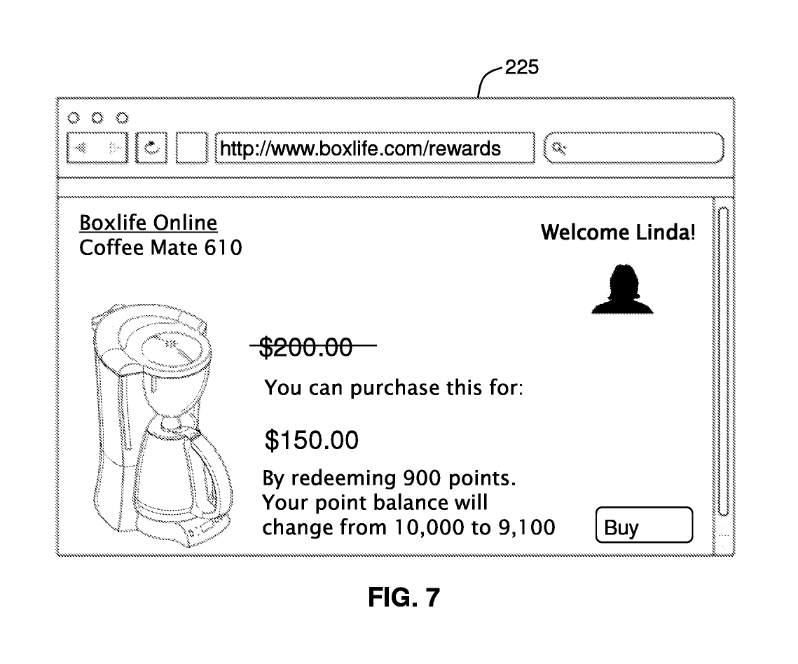

FIG. 7 shows receiving the discount at a different redemption rate by a different user. Here, a hypothetical user (e.g., “Linda”) sees that she may receive a $50 discount by redeeming 900 points—defining a personalized redemption rate for this user for this purchase.

By proffering personalized redemption rates, systems and methods of the invention allow consumers to access products at ultimately different costs, even where the facial dollar amount of the instant transaction is the same. It may be found that consumers would be alienated by apparently discriminatory pricing. Here, a redemption rate is determined based on variables such as a consumer's frequency of earning points, total points earned, other activities, or a combination thereof. Each transaction may be executed by different users for the same instant cost, but the applied incentive may cause the depletion of the corresponding user's rewards points by a personalized amount based on a personalized redemption rate.

In a preferred embodiment, the number of points required to achieve a specific discount level changes based on a unique algorithm that creates a point allocation from: a total points earned (more points means fewer are required for the discount level); a frequency of points earned (more frequent point earning transactions increase points weighting or fewer points required to achieve the discount); average social network activity over a period (e.g., past 30 days); how recent a last transaction was (more recent transaction gives a higher point weighting with a result that few points are required to get the discount); time of day (e.g., more points are awarded during non-peak periods); others; or a combination thereof. The invention provides methods for determining discounts or for granting pre-determined discounts and depleting points according to personalized redemption rates and for presenting discounts to consumers.

In some embodiments, systems and methods of the invention make use of a discriminant factor. A discriminant factor may be a stored value based on business rules, a calculation, decisions and input by an administrator, or received from an extrinsic source. A discriminant factor may be a status in a rewards program, for example.

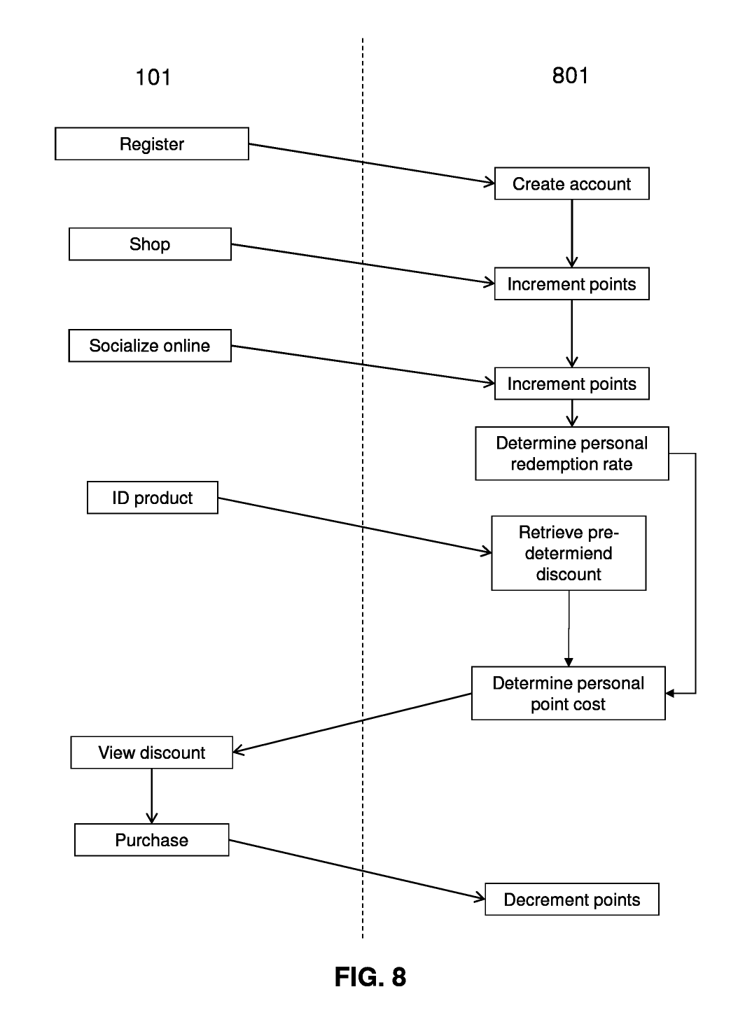

FIG. 8 diagrams methods of the invention. A consumer performs activities and transactions using a mobile device 101, a computer device 201, or both. Aspects and components of a rewards program may be performed through the use of a server computer 801. In general, a consumer will use a computer device to register for a program. A server is used to create an account for the user. As discussed above, a consumer earns points by shopping and social activity. Program instructions executed via the server computer cause a tally of the consumer's earned points to be incremented. Additionally, the server system may be used to determine a redemption rate.

To redeem points, a consumer may identify a product. A consumer may identify a product to the system by scanning the product (e.g., in store by QR code or barcode), by initiating the use of a store's POS system, or by shopping for the product online. For a given purchase, the system 801 can retrieve a pre-determined discount and use the consumer's redemption rate to determine a personal point cost for that purchase for that consumer. The consumer views the discount via device 101 and makes the purchase. Server system 801 can then deplete the consumer's account of points in the amount of the determined point cost.

An additional feature for companies that are trying to sell a particular item, is an ‘Instant Offer’. This is a discount provided beyond the standard three choices designed to motivate the user to make that purchase immediately. It may be time-based (in the next five minutes), provided as a ‘surprise’, and once the offer expires it is not available after the time limit.

In other embodiments, points can be made equal to a specific dollar amount. Points can also be allocated to missions specifically or to mission categories. A consumer can earn points via the missions and redeem the points up to a maximum discount on any item (e.g., half off, free, or rebate coming). For example, in some embodiments, a retailer defines the value of a mission by category: bringing someone shopping with you-50 points; uploading or broadcasting on a social media site such as one of those maintained under the trademarks TWITTER or FACEBOOK—5 point each; re-tweeting or commenting about a purchase on another person's social media “wall”—10 point; uploading a picture or video while shopping—15 points; purchasing a new items at full retail price—100 points for each $10 spent; others; or a combination of these. The consumer then can redeem as many of their points as they like up to a maximum and the price rolls back before their eyes as they enter how many points they want to redeem.

In certain embodiments, systems and methods of the invention include use of a POS Interface. Components of a rewards program can be administered using any product or POS system by simply either scanning a Bar Code or QR Code on the item or on the bill for the item (such as a restaurant receipt). A built in scanner module can be provided as part of an application that can capture price information (e.g., reflected on a restaurant bill) and calculate a discount based on the above criteria in real time. Use of a mobile app or application with mobile device 101 can provide an in-store rewards experience in some embodiments.

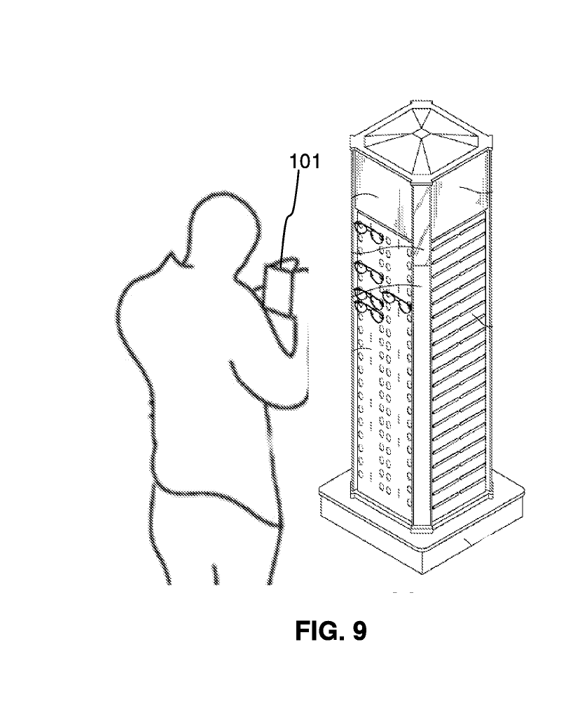

FIG. 9 illustrates identifying a product. Here, a consumer has identified a product in-store that they may wish to buy and is using mobile device 101 to interact with a rewards program.

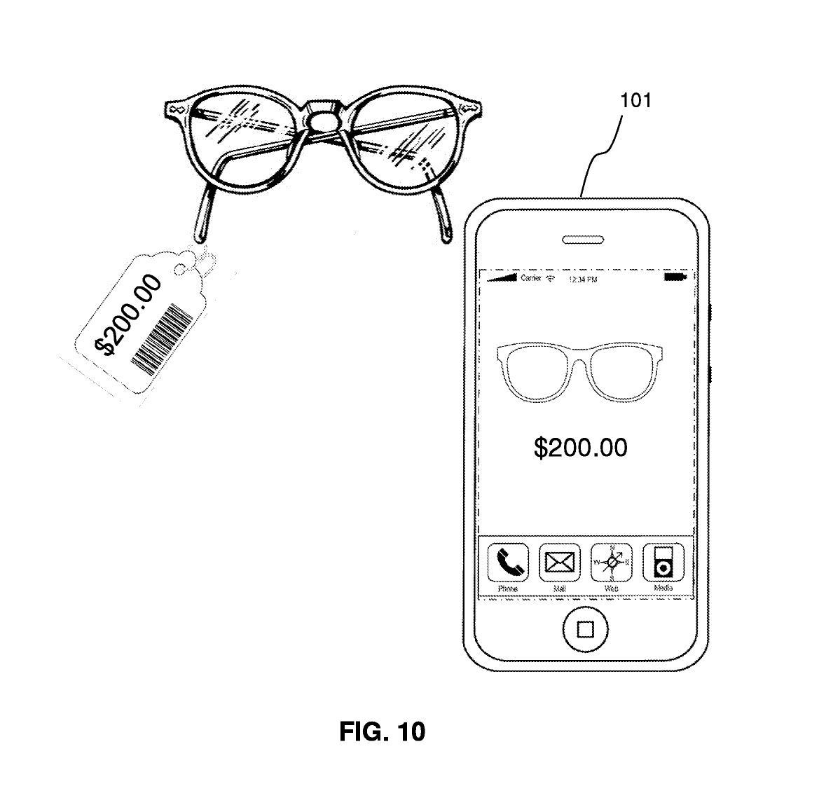

FIG. 10 shows an interaction with a rewards program via mobile device 101 in detail. Having identified a product of interest, a user can then identify the product using device 101. Identification can include looking up the product online, or scanning a QR code or barcode (pictured). Mobile device 101 can present a retail device for the product. By interacting with rewards program (e.g., through server 801), a consumer can be offered a discount on the product.

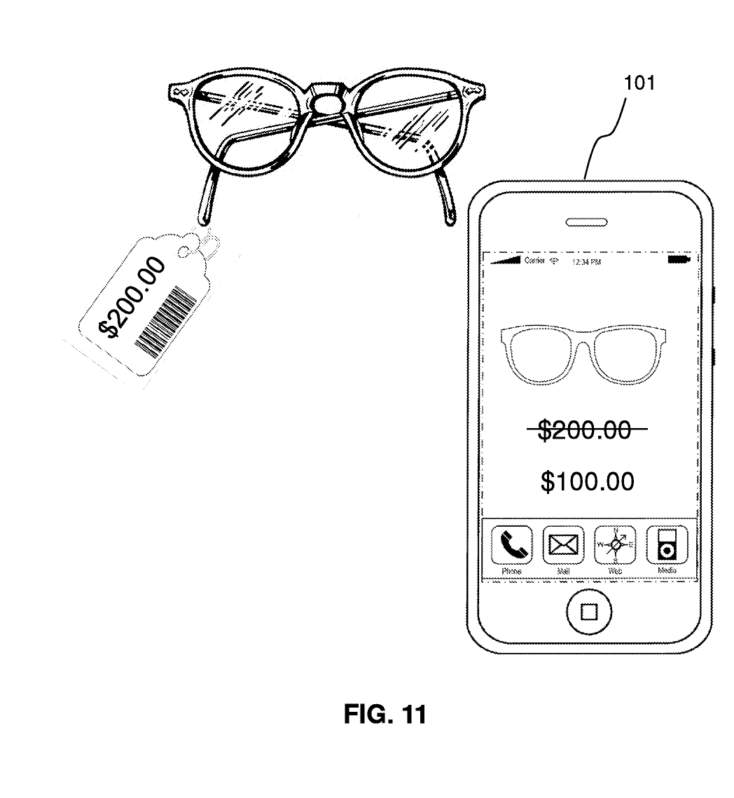

FIG. 11 shows viewing a discount via a device. Here, the consumer sees the price for the product roll back to a discounted price right before their eyes. This may reflect a real-time facet of the invention in some embodiments. For example, where the discount is pre-determined and simply looked up via software, and a user's redemption rate is calculated according to a formula, a display of the invention can present a discount in real time as a user inquires about a product incentive. The redemption rate will deplete the user's account by a personalized amount if the user makes a purchase.

A rewards program is preferably administered through the use of a system that includes a computer server system 801 and at least one user computer device 101.

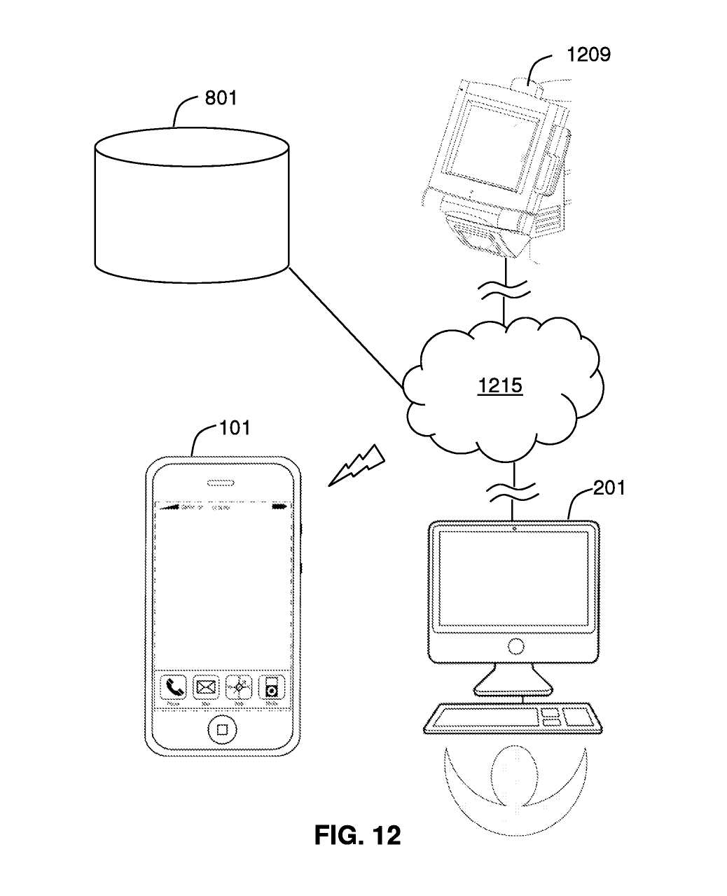

FIG. 12 depicts components of a system of the invention. Server 801 communicates with user computer device 201 or mobile device 101 via network 1215. A retailer's POS system 1209 can also be connected via network 1215. Use of server 801 allows features and components of a rewards system to be executed and maintained (e.g., even when no particular consumer is connected or using a computing device 101). A server 801 may include software suited for implementing methods described herein. One of skill in the art will appreciate that methods described herein can be implemented using any suitable programming language, development environment, or combination thereof. For example, Java, Ruby on Rails, Groovy and Grails, Perl, C++, or other development products may be employed to deploy the functionality, systems, and methods described herein. In some embodiments, server 801 includes executable instructions (e.g., program code in modules or objects). Additionally, server 801 an provide a business rules engine and a dashboard (e.g., as can be accessed via a user such as an administrator of a rewards program through the use of a computer device 201). A business rules engine can be used that increases or decreases the frequency of missions based on a set of algorithms that can include: a speed of completion (users that accept and complete missions quickly are sent new missions at a greater rate until their completion speed changes); a maximum threshold of each ‘type’ of mission (e.g., set at the beginning of the program to allow the program sponsor to predict and manage their discount liability); others; or a combination thereof.

In some embodiments, a type of mission completed will trigger a sequence of linked missions based on the completion of prerequisite missions. For example, if the first mission in the Harry Potter Quest is the completion of a mission to find Herminie Grainger's wand, the next mission involves using her wand to complete the second mission. This is triggered by uploading the Proof of Completion associated with finding the wand. In a retail setting, a customer sent a mission to upload a picture to Facebook that does not respond across a time period is not sent further Facebook related missions unless their profile changes with a Facebook login. However, if they are sent a mission to send a tweet, this can trigger more missions suggesting tweeting until their response to those missions changes.

A user's location may also trigger a specific type of mission based on the ‘earn’ and ‘redeem’ partners included in their profile. If the user indicates they are interested earning or redeeming rewards at Appleby's and they appear within 500 feet of an Appleby's restaurant, the business rules engine would trigger those specific missions. Secondly, a business rules engine may determine, based on the user's previous behaviors (they accepted 3 Appleby's missions and no Panera Bread Missions), what missions they are likely to complete. These missions can also be triggered based on location and businesses where a user has “checked in” (via a program such as one of those sold under the trademark FACEBOOK or FOURSQUARE) or have “mentions” on Twitter.

Server 801 may additionally provide software for predictive analytics via a data analytics module that gathers the results of program participation or mission history by all of the users participating in the program and provide interested “Earn” and “Redeem” partners with insight into which program components or missions achieve the greatest response and what levels of discounts offered create the most significant behavior change, especially in both purchase behavior and social advocacy. Using predictive analytics, a company's designated administrator can conduct an analysis of price and volume performance on product categories for their competitive set and see where they rank across a set of criteria. Predictive analytics can analyze average social network activity over a period (e.g., past thirty days). The invention also provides a marketer with next logical product offers to customers and third parties based on mobile scanning history that did not lead to conversion.

In certain embodiments, an analytics module can use data mining to analyze consumers' social activities, purchase behaviors, browsing behaviors, other records, or a combination thereof. The analytics module can provides a marketer the ability to choose the social channels that specific customer segments are demonstrating—based on their actual behaviors—to be most relevant to improving the ROI for marketing investments. A predictive analytics module may, based on the response from a critical mass of customer segments to specific types of missions, provide a forecast as to what changes a retailer might expect to see in terms of changes in store traffic or purchases based on the launch of specific missions or program components that have proven to generate specific customer behaviors.

Server 801 may optionally include a transaction and settlement module. For example, where a rewards program is implemented under a multi-party model, customer participant firms that choose to provide financial rewards need to settle the pay back of the given financial rewards to the company's funding the discounts. For example, if Panasonic agreed to fund the rollback for the purchase of their Digital TV at a Best Buy Store, the invention settlement system settles involved accounts and creates payments withdrawals and deposits via escrow accounts at the end of a pre-defined time interval of participating companies.

Systems and methods of the invention such as the components and features described herein can be implemented through the use of devices configured to execute functionality described herein.

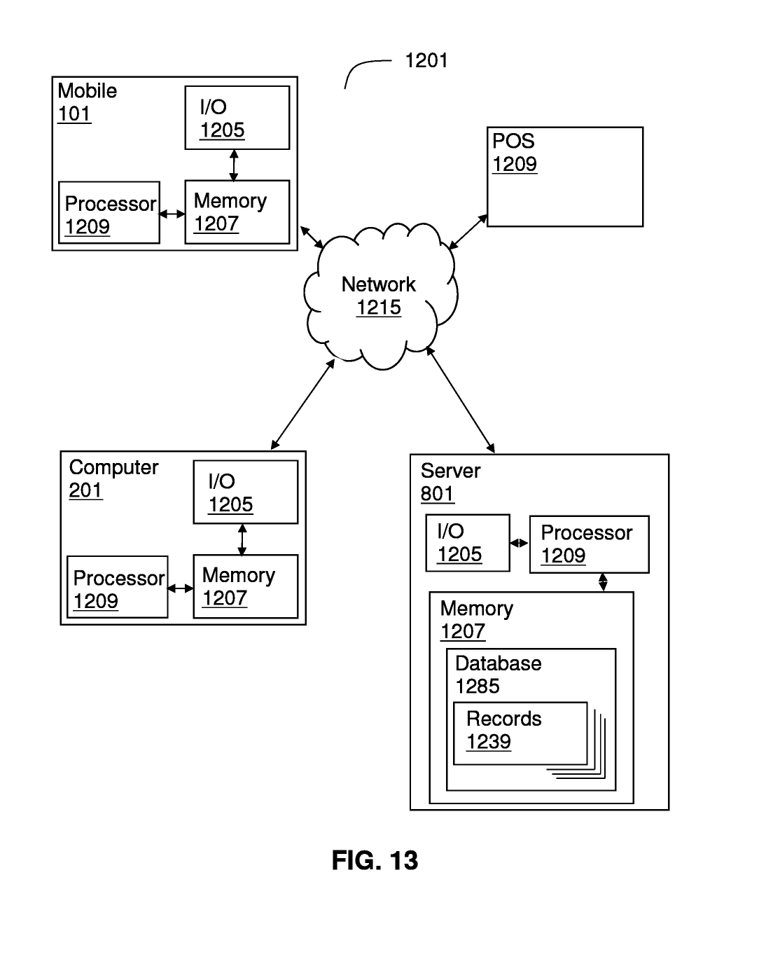

FIG. 13 diagrams components of a system 1201. Preferably, any of mobile device 101, computer device 201, or server 801 may include a processor 1209 coupled to a memory 1207 and an input/output (I/O) device 1205). A processor generally refers to a computer microchip such as the processor sold under the trademark CORE 17 by Intel (Santa Clara, Calif.). A memory 1207 generally includes one or more devices for random access, storage, or both. Preferably, memory 1207 includes a tangible, non-transitory computer readable medium, and may be provided by one or more of a solid state drive (SSD), a magnetic disc drive (aka, “a hard drive”), flash memory, an optical drive, others, or a combination thereof. I/O device 1205 may include one or more of a monitor, keyboard, mouse, touchscreen, Wi-Fi card, cell antenna, Ethernet port, USB port, light, accelerometer, speaker, microphone, drive for removable disc, others, or a combination thereof. Preferably, any combination of mobile device 101, computer device 201, server 801, and POS 1209 may communicate through the use of a network 1215, which may include communication devices for internet communication, telephonic communication, others, or a combination thereof. In certain embodiments, server system 801 will include a processor 1209 coupled to a tangible, non-transitory memory 1207 and contain instructions executable by processor 1209 to cause server system 801 to perform functions described herein.

Systems and methods of the invention allow a retailer to provide precise, personalized discounting not through price, but through what is required in points to redeem a fixed discount or a maximum. This protects the retailer's level of markdown while still incenting the desired consumer behaviors: frequent visits, high conversion, higher average ticket and higher traffic while minimizing the impact to gross margins.

Systems and methods of the invention include points allocation that can be calculated in real-time based on algorithms that influence the consumer while taking into account a value of the consumer and, by proxy, the consumer's profile, to a retailer or administrator of a rewards program. A value can be influenced by a consumer's demonstrated shopping and social behavior, a retailer's desire to sell the item, or both.

Systems and methods of the invention allow the flexibility to move unwanted inventory through “Instant Offers” that surprise and delight the consumer in an unpredictable way.

Systems and methods of the invention can be structured to include points redemption for things other than discounts such as, for example, favored treatment when new products are introduced, special hours, a designer ‘meet and greets’, an invitation to a trunk show, others, or a combination thereof. In certain embodiments, points are redeemed for incentives that cost the retailer little but would be of high value to the consumer.

Using systems and methods of the invention, a retailer is in a real-time dialogue with their customer and with that, their location, preferences, price tolerances for specific items and style preferences are tracked and predicted over time. One of skill in the art will recognize features that can be used to deploy a rewards program. For example, rewards programs are discussed in U.S. Pat. No. 8,285,588 to Postrel; U.S. Pat. No. 6,571,216 to Garg; U.S. Pub. 2013/0054327 to Ross; U.S. Pub. 2013/0073351 to Bair; U.S. Pub. 2012/0215608 to Paulos; U.S. Pub. 2012/0239465 to McInnes; and U.S. Pub. 2010/0274655 to Postrel, and the contents of each of those are incorporated by reference in their entirety for all purposes.

As used herein, the word “or” means “and or or”, sometimes seen or referred to as “and/or”, unless indicated otherwise.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A method of influencing consumer behavior comprising using a computer system comprising a processor coupled to a non-transitory memory for:
giving, using the processor, consumers reward points for performing activities;
determining, using the processor, a redemption rate for each consumer;
offering, using the processor, the consumers a discount on a purchase; and
for each consumer that accepts the offer, depleting, using the processor, that consumer's reward points by an amount inversely proportional to that consumer's redemption rate.

2. The method of claim 1, further wherein the method comprises giving consumers reward points for performing activities that include the use of a social network website and the purchasing of a product.

3. The method of claim 1, wherein offering the consumers a discount on a purchase comprises:
providing the consumer with a computer executable application that a consumer can execute on a mobile computing device to cause the mobile device to scan a product code; and
displaying on the mobile device a discounted price for product.

4. The method of claim 3, wherein displaying the discounted price comprises:
displaying an original price number;
displaying a transition; and
displaying a final discounted price number.

5. The method of claim 4, wherein the transition is an animation comprising numbers between the original price number and the final discounted price number.

6. The method of claim 1, further wherein the method comprises giving consumers reward points for performing activities that include performing assigned missions.

7. The method of claim 6, further comprising verifying completion of the assigned missions by receiving an image from a consumer.

8. The method of claim 6, wherein the assigned missions include recommending a product through the use of a web site.

9. The method of claim 6, further comprising assigning the missions to a consumer.

10. The method of claim 9, wherein the missions are assigned at a frequency that is influenced by a speed of completion of previously-assigned missions.

11. The method of claim 1, wherein the determining a redemption rate for each consumer comprises calculating a value for a function in which one variable is one selected from the list consisting of:
an amount of points earned;
a frequency at which points have been earned;
an amount of social network activity in a period of time;
a time since a last transaction;
a time of day; and
a company defined discriminant factor.

12. The method of claim 1, wherein the determining a redemption rate for each consumer comprises calculating a value for a function in which variables comprise:
an amount of points earned; a frequency at which points have been earned; an amount of social network activity in a period of time; a time since a last transaction; a time of day; and a company defined discriminant factor.
